(19) United States
(12) Patent Application Publication
(10) Pub. No.: US 2008/0263147 A1
(43) Pub. Date: Oct. 23, 2008

(54) METHOD OF RESERVATION

(75) Inventors: Gregor PONERT, Salzburg (AT); Dirk FOX, Bischofswiesen (DE)

Correspondence Address: DAVIS BUJOLD & Daniels, P.L.L.C., 112 PLEASANT STREET, CONCORD, NH, 03301, US

(73) Assignee: SKIDATA AG, Grodig/Salzburg (AT)

(21) Appl. No.: 12/107,347

(22) Filed: Apr. 22, 2008

(30) Foreign Application Priority Data
Apr. 23, 2007 (EP) 07008221.9

(51) Int. Cl. G06F 15/16

(52) U.S. Cl. 709/203

(57) ABSTRACT

A method for reserving a service from inside a vehicle (A) at one of several facilities providing such service. The vehicle (A) having a navigation apparatus (1) which is equipped for data communication with a reservation server (3). Each service-providing facility has a reading mechanism (11, 12). The navigation apparatus (1) is adapted to display the service-providing facilities within an area to which the vehicle (A) is traveling. Using the navigation apparatus (1), the user selects one of the displayed service-providing facilities and communicates a reservation for the desired service—together with user identification data—with reservation server (3) at the selected facility. Upon arrival at the selected facility, a reading mechanism (11, 12) reads the identification data and grants access to the desired service, if the user identification data agrees with the data previously communicated to the reservation server (3).

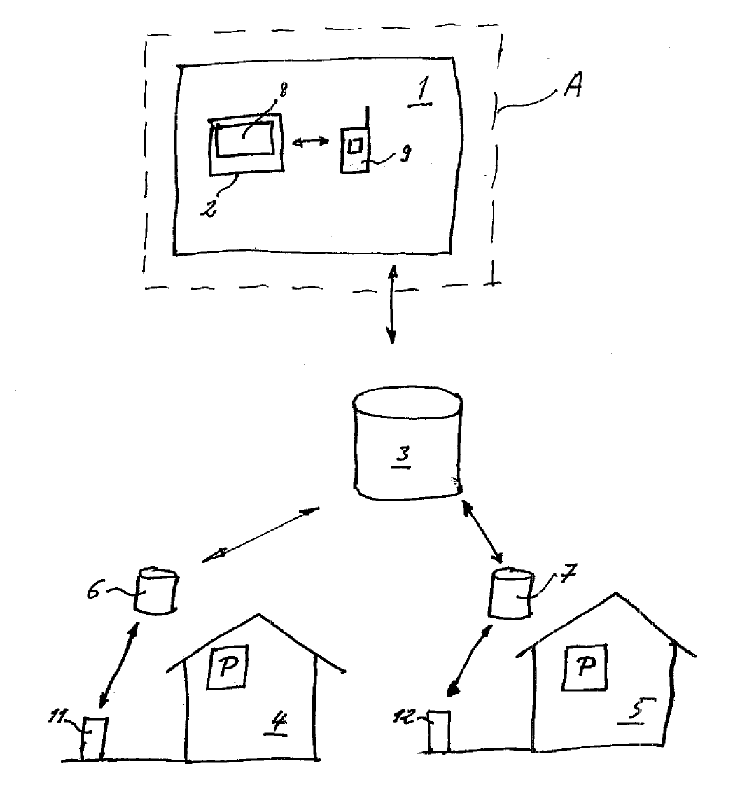

This application claims priority from European Application Serial No. 07008221.9 filed Apr. 23, 2007.

### FIELD OF THE INVENTION

The invention relates to a method of reserving a service from inside a vehicle at one of several facilities offering that service.

### BACKGROUND OF THE INVENTION

A motorist wishing to avail him- or herself of a service and approaching to this end a facility providing that service may find out on arrival at the facility that the desired service is no longer available. At this point, extended trips may be necessary to find a facility where the desired service can be secured.

For example, consider an area such as a town where a plurality of car parks or like facilities is available. The motorist normally approaches the facility which is nearest to his/her target location, on the one hand, and which can be expected to offer an as yet unoccupied parking position, on the other. In many cases, he/she is disappointed in that expectation and extended trips from one parking facility to another may be necessary until he/she finally finds a free parking position.

### SUMMARY OF THE INVENTION

The object of the invention is a substantial simplification of the search for a facility where the desired service is available.

For finding a facility providing the service and for reserving a desired service at that facility, the invention provides for the vehicle being equipped with navigation equipment such as a GPS device. The navigation device may be installed inside the vehicle or may be a portable device carried along in the vehicle. The navigation device is configured for data communication with a reservation server loaded with the services available at the facilities offering the service.

To this end, each service-providing facility may have associated therewith a database, which the reservation server will interrogate as to which services are available at the facility in question.

In a first step, the user, viz. the motorist or another passenger in the vehicle, selects the facility at which he/she wishes to avail himself of a service. To this end, he/she may enter in the navigation device his/her target address or a target area, responsive to which entry the display of the navigation device will show on its display one or several facilities which are located near that target address and offer the desired service. Of these facilities, the user will select one.

The user-selected facility may then be issued identification data useful for effecting the reservation—such as the geographic coordinates of the facility displayed on the navigation device. On the basis of these identification data, the user may then issue a reservation enquiry to the reservation server by data communication using the navigation device, which is equipped for data communication.

In this respect, the navigation device may itself be configured for direct data communication with the reservation server; alternatively, an additional communication terminal may be provided so as to provide the navigation device with data communication capabilities. An additional communication terminal may comprise a mobile telephone or a wireless LAN link, for example. The reservation server may then interrogate the server for the services offered by the selected facility for availability and return the information to the communication terminal or directly to the navigation device.

If no service is available, the reservation server may inform the user via his/her navigation device of the nearest facility where the service is available so that the user may place his/her reservation thereat.

If the service is available, the user finalizes the reservation, i.e. he/she uses the navigation device or the communication terminal to confirm the reservation. In the process, user identifying data is communicated to the reservation server.

Such user identification data may be data identifying the navigation device or the communication terminal, such as the telephone number of the mobile telephone, but also any data uniquely attributable to the user or the vehicle, such as the vehicle's registration plate number. Alternatively, the identifying data may be stored on a separate electronic data storage media such as a storage card.

The reservation and the user ID data may be communicated on-line by the reservation server to the database of the facility providing the service. On the user's arrival at the service-providing facility, the data identifying him is read by reading means located thereat and linked to the database of the service-providing facility and the reservation server, respectively. The ID data may be read at the service-providing facility by RFID means, such as a near-field communication (NFC) system. In that case, the user identifying data may be the ID data of the NFC device, such as a serial number.

If the identifying data comprises the license number of the motor vehicle, a reading device capable of reading motor vehicle registration plates may be used at the entrance to the service-providing facility.

If the identifying data read by means of the reader conforms with the user ID communicated by the reservation server, the user is granted access to the desired service.

At the same timer the user ID data used to place the reservation, such as the registration plate number of the motor vehicle, the ID data of the navigation device or the communication terminal, or the ID data stored on the electronic data storage media, may be used to pay for the claimed service.

The service-providing facility may be a parking area and the service itself a parking position for the vehicle in that parking area, the ID reader being installed at the entrance of that parking area. The parking area may be an in-door car park or an open-air parking lot.

Once a parking position in a parking area has been reserved and the user ID data read by the reader conforms with the user ID data communicated by the reservation server, the entrance is opened and the user assigned a parking position.

In this respect, the parking area may include means for monitoring each individual parking position or a storey-wise counting system. The position monitor or the storey-wise counting system is interrogated and the user informed of the free parking position at the entrance. To this end, a display unit may be installed at the entrance or the free position shown on the display of the navigation device or of the mobile telephone. Also possible is an audible communicating means such as the loudspeaker of the navigation device or of the mobile telephone.

Further, a printer may be provided at the entrance to provide a print-out of the storey and/or the number of the parking position on a slip of paper to be issued to the user.

Following assignment, the assigned parking position is marked as having been reserved. This may be done optically by signaling means installed at the position, such as a luminous indicator or a message display. Thus, the name, the registration plate number of the motor vehicle or other ID data may be displayed.

The invention is not limited to the reservation of a parking position in a parking area; it is intended generally to reserve a service from inside a vehicle after one of several facilities providing that service has been selected. The service-providing facility may be any point of interest. That point of interest or the service-providing facility may be a restaurant or a hotel, with the service comprising a seat in the restaurant or a room in the hotel, in which case the reader may be installed at the entrance, at the reception desk or at the door to the reserved room, for example. Further, the service-providing facility may be a cinema, a theatre or the like event location having seats. Thus, the ID data assigned to the user may be stored on a data storage media the user is carrying on him.

Further alternatively, the point of interest may be a leisure facility. Thus, and for example, the user approaching a target area such as a town may call up for display on the navigation device multiple leisure facilities such as a sports stadium, a cinema, a public swimming pool, and the like, with the user using the navigation device to select one of these facilities, where after he/she may use the navigation device to issue to the reservation server a reservation request together with the ID assigned to the leisure facility, with the reservation server having had the availability of free user capacity communicated to it by the leisure facility itself. Using the navigation device configured for data communication, the user will then place a reservation via the reservation server at the leisure facility having free capacity.

Further, the point of interest may be a transport facility such as a leisure transport facility like a ski-lift or a cable car.

Thus, during a trip to a skiing area, the display on the navigation device may be used to show several lifts or the like personal transport facilities, of which the user may select one. For selection, the navigation device may be used to issue a reservation request together with the data identifying the personal transport facility to the reservation server, which has been informed of the availability of the various personal transport facilities in a form such as their waiting periods.

Using the navigation device equipped for data communication, the user then places his/her reservation, via the reservation server, with the transport facility featuring the desired short wait. To this end, the navigation device is used to communicate to the reservation server the ID data assigned to the user. At the leisure or transport facility's, the reader may be installed at the entrance or access, for example. As the user enters the facility, the reader picks up the user-assigned ID data from a data storage media the user carries along with him. At the time the reservation is placed, the reservation server communicates the user ID data to the selected facility, where the data is supplied to the reader. If the user ID communicated by the reservation server conforms with the user ID the reader has ascertained, the user is granted access to the leisure-time or transport facility.

Instead of a lift or a personal transport facility the point of interest or the service-providing facility may be one of several skiing regions within a greater skiing area. If the user-assigned identifying data a reader located in a skiing region has read from a data storage media conforms with the ID data communicated to the reservation server, the user is granted the right to utilize several—if not all—of the lifts and the like personal transport means in the skiing region at issue.

The reservation may be applied to a specific seat, parking position or room upon arrival at the respective facility and following the reading of the user identification. In addition, reservation status of the parking position or seat or room may be indicated by optical or mechanical means, the former e.g. by showing the license place number of the vehicle on a display and the latter e.g. in the case of a room by means of a key or, in the case of a parking position, by a mechanical barrier.

The invention will be explained in greater detail below by means of an exemplary reservation of a parking position under reference to the attached drawing, the single FIGURE of which schematically shows the various steps involved in the reservation procedure.

### BRIEF DESCRIPTION OF THE DRAWINGS

An embodiment of the invention is explained in greater detail below under reference to the attached drawing, the single FIGURE of which schematically shows the various steps involved in the reservation of a parking position.

### DETAILED DESCRIPTION OF THE DRAWINGS

With reference to the FIGURE, vehicle A is equipped with navigation apparatus 1 comprising a GPS navigation device 2, for example. Navigation apparatus 1 is equipped for data communication with a reservation server 3 adapted to receive information relating to the availability of free parking positions in various car parks or the like parking areas 4, 5.

To this end, each parking area 4, 5 may have associated therewith a database 6 or 7, respectively, to be interrogated by reservation server 3 as to the availability of free parking positions in parking area 4 or 5, respectively.

In a first step, the user in motor vehicle A moves to parking area 4, 5 where he/she wishes to park the vehicle. To this end, he/she may enter his/her target address in navigation device 2, whereupon display 8 thereof shows the parking areas 4, 5 located in the vicinity of the target address.

The user selects one of parking areas 4, 5, with the selected parking area having identification data assigned thereto for subsequent use for reservation. These identification data may comprise the coordinates of parking area 4, 5 shown by navigation device 2. On the basis of these identification data the user relies on the data communication capability to issue a reservation request to reservation server 3. To this end, navigation apparatus 1 may be configured for direct data communication with reservation server 3. Alternatively, an additional communication transmitter 9 such as a mobile telephone may be used for data communication from the vehicle to reservation server 3. In response, reservation server 3 interrogates database 6, 7 of the respective parking area 4, 5 on-line for available parking positions and reports the resultant information directly to navigation apparatus 1 or communication terminal 9, i.e. the user is told whether a parking position is available or not in parking area 4, 5.

If no parking position is available, reservation server 3 may inform the user on the display 8 of his/her navigation device 2 of the nearest parking area 4, 5 where parking positions are available so that the user may proceed to reserve one of them.

For reserving a parking position, navigation apparatus 1 is used to communicate to reservation server 3 the reservation itself together with the identification data assigned to the user.

The identification data assigned to the user may comprise data identifying navigation device 2 or communication terminal 9, e.g. the telephone number of the mobile telephone. The identification data may be read from navigation device 2 e.g. by near-field communication (NFC), i.e. a wireless communication technology for short-haul data links.

Further, the identification data assigned to the user (to be read by communication terminal 9 e.g. by NFC and to be transmitted by communication terminal 9 to reservation server 3 may be stored on an electronic data storage media such as an RFID element like an RFID card.

The reservation and the identification data assigned to the user are supplied to database 6, 7 of parking area 4, 5. On arrival of the user's vehicle A at parking area 4, 5, a reader 11, 12 at the entrance to parking area 4, 5 reads the user identification data. To this end, reader 11, 12 is linked to database 6, 7 of the respective parking area 4, 5. Reading the user identification data from navigation device 2, communication terminal 9 or the data storage media by means of reader 11, 12 may use NFC technology as well.

If the user identification data read by reader 11, 12 conform with the use identification data the reservation server 3 has communicated to databases 6, 7, the entrance to the parking area is unlocked and a parking position assigned to the user by showing it on display 8 of navigation device 2, for example.

1.-19. (canceled)

20. A method of reserving a service from inside a vehicle (A) from at one of several facilities providing such service, the vehicle (A) having a navigation apparatus (1) configured for data communication with a reservation server (3) and the service-providing facilities each having a reader (11, 12), the method comprising the steps of:
displaying, with the navigation apparatus (1), service-providing facilities located within a selected area,
using the navigation apparatus (1) to select one of the service-providing facilities and communicating to the reservation server (3) a reservation of the service at the selected service-providing facility together with identification data assigned to the user; and
upon arrival at the service-providing facility, reading the user identification data by the reader (11, 12) thereof, and granting the user access to the reserved service if the read user identification data agrees with the user identification data communicated to reservation server (3).

21. The method according to claim 20, further comprising the step of issuing to the reservation server (3) a reservation request and identification data associated with the selected service-providing facility, with the reservation server (3) having been informed previously of the services available at the selected service-providing facility, following the selection of the service-providing facility and prior to communicating the reservation of the service by means of navigation apparatus (1) equipped for data communication.

22. The method according to claim 21, further comprising the step of providing, as identification data associated with the service-providing facility, geographic coordinates thereof as determined by the navigation apparatus (1).

23. The method according to claim 20, further comprising the step of configuring the navigation apparatus (1) with a navigation device (2) and a communication terminal (9) for data communication with the reservation server (3).

24. The method according to claim 20, further comprising the step of defining the user assigned identification data as data identifying one of a navigation device (2) and communication terminal (9).

25. The method according to claim 23, further comprising the step of storing the user assigned identification data on an electronic data storage media which is readable by the communication terminal (9) and the reader (11, 12) at the selected service-providing facility.

26. The method according to claim 23, further comprising the step of linking at least one of the navigation device (2) and the communication terminal (9) and the electronic data media and the communication terminal (9) by near-field communication.

27. The method according to claim 20, further comprising the step of defining the user assigned identification data as a license number of the vehicle.

28. The method according to claim 20, further comprising the step of reading, with the reader (11, 12) at the selected service-providing facility, the user assigned identification data with near-field communication technology.

29. The method according to claim 20, further comprising the step of enabling the reader (11, 12) at the selected service-providing facility to read vehicle registration plates.

30. The method according to claim 20, further comprising the step of connecting the reservation server (3) with databases (6, 7) located at each of the plurality of service-providing facilities and storing services available at each of the plurality of service-providing facilities.

31. The method according to claim 20, further comprising the step of defining the plurality of service-providing facilities as parking areas (4, 5) and the service provided by the plurality of service-providing facilities is parking the vehicle (A) in a parking position within the parking area (4, 5).

32. The method according to claim 31, further comprising the step of communicating the user-assigned parking position within the parking area (4, 5) to the user on a display means (8) located at least one of inside the vehicle (A) and at an entrance to the parking area (4, 5).

33. The method according to claim 31, further comprising the step of printing the user-assigned parking position within the parking area (4, 5) on a ticket by means of a printer located at the entrance to the parking area (4, 5).

34. The method according to claim 20, further comprising the step of defining the service-providing facilities as a facility having one of rooms and seats.

35. The method according to claim 31, further comprising the step of associating the reservation with at least one of a specific parking position, a seat and a room upon arrival at the service-providing facility and after reading the user identification data.

36. The method according to claim 31, further comprising the step of identifying at least one of a specific parking position, a seat and a room as having been reserved by one of optical and mechanical means.

37. The method according to claim 20, further comprising the step of defining the service-providing facilities as a leisure facility.

38. The method according to claim 20, further comprising the step of defining the service-providing facilities as a transport facility.

39. A method of reserving, from inside a vehicle (A), a service from one of a plurality of facilities (4, 5) providing a desired service, the method comprising the steps of:
enabling a navigation apparatus (1) of the vehicle (A) to communicate with a reservation server (3);
displaying, on the navigation apparatus (1), the plurality of service-providing facilities (4, 5) located within a selected destination area;
selecting with the navigation apparatus (1) one of the plurality of service-providing facilities (4, 5);
communicating, via the navigation apparatus (1), a reservation with the reservation server (3) for the service at the selected service-providing facility (4, 5);
communicating, via the navigation apparatus (1), with the reservation server (3) to transfer user specific identification data therebetween;
reading the user specific identification data with a reader (11, 12), which is associated with the selected service-providing facility (4, 5), upon arrival of the vehicle (A) at the selected service-providing facility (4, 5); and
granting the user access to the reserved service, if the user specific identification data read by the reader (11, 12) agrees with the user specific identification data previously communicated between the navigation apparatus (1) and the reservation server (3).
